(19) United States
(12) Patent Application Publication
(10) Pub. No.: US 2026/0221684 A1
(43) Pub. Date: Jul. 30, 2026

(54) Electrical Connector Assembly and Electrical Connector

(71) Applicants: Tyco Electronics (Shanghai) Co., Ltd., Shanghai (CN); Tyco Electronics Technology (SIP) Co., Ltd., Suzhou (CN)

(72) Inventors: Zhide Dong, Suzhou (CN); Rongyan Lu, Suzhou (CN); Chengjun Zou, Suzhou (CN); Shiwen (Matt) Chen, Shanghai (CN); Jiawen (Gavin) Lu, Shanghai (CN)

(73) Assignees: Tyco Electronics (Shanghai) Co., Ltd., Shanghai (CN); Tyco Electronics Technology (SIP) Co., Ltd., Suzhou (CN)

(21) Appl. No.: 19/453,650

(22) Filed: Jan. 20, 2026

(30) Foreign Application Priority Data
Jan. 27, 2025 (CN) 202510127489.7

(51) Int. Cl. H01R 13/424; H01R 13/502

(52) U.S. Cl. CPC H01R 13/424; H01R 13/502

(57) ABSTRACT

An electrical connector assembly includes a terminal assembly and a shell. The terminal assembly includes a conductive wire having a multi-strand wire harness having inner cores, and molded first and second housing portions fitting with each other to define a hollow accommodation portion for accommodating the inner cores from which a shielding layer has been removed. Conductive cores of the inner cores, from which insulating layers have been removed, extend out of a leading-out end of the accommodation portion. The shell includes first and second outer shells fitting with each other to define a space accommodating the terminal assembly. The second outer shell extends in a direction angled relative to a direction the first outer shell extends in. The multi-strand wire harness and the accommodation portion are bent and received within the shell. Terminals of the terminal assembly are electrically connected to the conductive cores at the leading-out end.

### CROSS-REFERENCE TO RELATED APPLICATIONS

This application claims the benefit of the filing date under 35 U.S.C. § 119(a)-(d) of Chinese Patent Application No. 202510127489.7, filed on Jan. 27, 2025.

### FIELD OF THE INVENTION

The present invention relates to an electrical connector assembly and an electrical connector and, more particularly, to a bent high-frequency electrical connector assembly applicable to different application requirements in, for example but not limited to, the field of on-board data transmission, and its electrical connector, as well as a method for forming the bent electrical connector assembly.

### BACKGROUND OF THE INVENTION

With the development of electronic technology, portable electronic devices are required to quickly, conveniently, and reliably electrically connect with a fixed electrical connector installed on another device, so that the electronic device can obtain electrical power from the another device or exchange data signals with the another device. For example, in automotive systems, it is desirable for on-board devices to quickly and reliably electrically connect with electrical connectors and their various electrical connector assemblies installed in the automobile.

An electrical connector assembly is an electronic component for the transmission and exchange of current, signals, etc., between electronic system devices. As a node, independently or together with a cable, the electrical connector assembly transmits current or signals between devices, components, equipment, and systems, and prevents changes in signal distortion and energy loss between the systems. It is an essential basic element constituting the connection of the entire complete system. For example, I/O modules are usually used for connections between switches and switches, and between switches and servers.

Electrical connectors are typically used to achieve signal transmission between two printed circuit boards (PCBs); specifically, as a typical example, each electrical connector contains its own electrical connector assembly, and the respective two mating electrical connector assemblies of a pair of electrical connectors are installed in their respective housings, and then the two electrical connector assemblies are mated together by locking their respective terminals relative to each other and subsequently locking their respective housings relative to each other, to achieve signal transmission between them. The electrical connector assemblies typically include an insulating housing (such as a plastic housing) and contact conductive terminals (including signal terminals and ground terminals) assembled in the insulating housing. Physical interconnection and electrical connection are achieved through the contact conductive terminals of the paired electrical connector assemblies assembled in the paired electrical connectors.

Considering that when paired electrical connector assemblies are interconnected, the straight-line structure of the electrical connector assembly sometimes cannot meet wiring requirements, making the cable of the electrical connector assembly inconvenient for routing, prone to interference with other components, and affecting the performance and lifespan of the connector. Therefore, on the basis of the original 180-degree straight-line cable exit design, a bent, i.e., inclined cable exit design is added, typically such as a product structure with a 90-degree tail cable exit, thereby generating in this field a bent electrical connector assembly which has a right-angle structure as its main structure.

In the bent electrical connector assembly, i.e., the right-angle connector, the flat mating end for cable terminals for plug-in mating with a socket of a matching electrical connector assembly, and the vertical termination end for bent, e.g., 90-degree tail cable exit, are substantially perpendicular to each other.

Bent electrical connector assemblies are typically manufactured using two structural methods, i.e., typical manufacturing methods, for example, by matching two types of terminals in the horizontal and vertical directions respectively, thereby achieving a bent electrical connector; alternatively, for example, by bending the terminals at 90 degrees, more specifically as an example, in some right-angle connectors, the central terminal body (e.g., in the form of a pin) for conductive contact is inserted into the dielectric housing of the electrical connector assembly, and is subsequently manually bent, e.g., at 90 degrees, using a tool, so as to form a signal transmission path through the right-angle corner portion of the bent electrical connector assembly, thereby achieving a bent electrical connector, typically a 90-degree or right-angle connector.

However, both structures of the bent electrical connector assemblies formed in different ways inherently have technical defects. Such bent electrical connectors have the disadvantages of many product parts and a complex assembly process, resulting in complex and costly design, manufacturing, and assembly. For example, because the signal path turns, e.g., at 90 degrees, within the dielectric housing of the electrical connector assembly (thereby forming a right-angle corner portion at the transition between the mating end and the termination end), it is difficult to maintain the impedance of such a connector between the mating end and the termination end. Furthermore, typical right-angle connectors do not allow automated manufacturing. Additionally, the dielectric housing is usually difficult to form so as to completely surround the terminal body at the bent right-angle corner portion, which may reduce shielding and cause attenuation of electrical signals.

On one hand, using only the design of conventional bent electrical connector assemblies, it is difficult to ensure that the position of the terminal remains locked in place relative to the wire and housing after assembly, and further difficult to ensure relative fixation and anti-detachment. And on the other hand, regarding the connection between the electrical connector assembly and the mating electrical connector assembly, the typical electrical connector assemblies and mating electrical connector assemblies are integrally provided with buckle structures that can be snapped together or separated. For example, the housing of the electrical connector assembly is provided with a stop buckle, and the housing of the mating electrical connector assembly is provided with an elastic buckle. When the electrical connector assembly and the mating electrical connector assembly are plugged together to achieve electrical connection, the elastic buckle snaps with the stop buckle, and the connector and the mating connector are buckled together. When it is necessary to disconnect the electrical connection, by pressing the elastic buckle, the stop buckle and the elastic buckle can be detached and separated from each other, and then the mating connector can be pulled out of the socket of the connector to disconnect the electrical connection. However, due to maloperation of the elastic buckle or harsh working conditions, it is extremely easy to cause separation from the stop buckle, causing the buckle connection to fail, thereby leading to failure of the electrical connection between the connector and the mating connector. Therefore, the connection between the connector and the mating connector is not reliable, such that the relative prescribed positioning of the connector as a whole cannot be ensured effectively; and the interface retention force achievable by the elastic buckle, for example, in a convex-concave engagement manner, is limited, instead of providing high retention force and reliable radio frequency electrical connection, self-locking function, good vibration resistance and meeting the need for quick plug-and-pull self-locking in harsh environments.

Therefore, there is an urgent need for an improved bent electrical connector assembly and its electrical connector, which can be achieved, for example, through improvements in the assembly structure, so that on one hand, it can effectively lock the terminal relative to the internal housing for holding the terminal (referred to as the terminal housing) and the external assembly housing, ensuring the terminal is fixed in place and will not detach, while still preventing withdrawal movement opposite to the insertion movement and axial displacement of the terminal body; on the other hand, it effectively ensures relative positioning and locking between different housing parts of the assembly housing relative to each other after assembly.

### SUMMARY OF THE INVENTION

An electrical connector assembly includes a terminal assembly and a shell. The terminal assembly includes a conductive wire having a multi-strand wire harness having inner cores, and molded first and second housing portions fitting with each other to define a hollow accommodation portion for accommodating the inner cores from which a shielding layer has been removed. Conductive cores of the inner cores, from which insulating layers have been removed, extending out of a leading-out end of the accommodation portion. The shell includes first and second outer shells fitting with each other to define a space accommodating the terminal assembly. The second outer shell extends in a direction angled relative to a direction the first outer shell extends in. The multi-strand wire harness and the accommodation portion are bent and received within the shell. Terminals of the terminal assembly are electrically connected to the conductive cores at the leading-out end.

### BRIEF DESCRIPTION OF DRAWINGS

The invention will now be described by way of example with reference to the accompanying figures, of which:

FIG. 1A is a perspective view of an electrical connector assembly according to an embodiment;

FIG. 1B is an exploded view of the electrical connector assembly of FIG. 1A;

FIG. 2A is a perspective view of an accommodation portion according to an embodiment, the accommodation portion is formed by fitting a second housing portion into a first housing portion in a first direction;

FIG. 2B is an exploded view of the accommodation portion of FIG. 2B;

FIG. 3 is a perspective view of the first housing portion of FIG. 2A;

FIG. 4 is a perspective view of the second housing portion of FIG. 2A;

FIG. 5 is an exploded view showing an overall structural arrangement of assembling the electrical connector assembly of FIG. 1A from several subassemblies assembled separately;

FIG. 6A is an exploded view of a first semi-finished subassembly according to an embodiment;

FIG. 6B is a perspective view of the first semi-finished subassembly of FIG. 6A;

FIG. 7A is a front view of a first outer shell according to an embodiment;

FIG. 7B is a top view of the first outer shell of FIG. 7A;

FIG. 7C is a perspective view of the first outer shell of FIG. 7A;

FIG. 7D is another perspective view of the first outer shell of FIG. 7A;

FIG. 7E is a longitudinal cross-sectional view of the first outer shell of FIG. 7A taken along an offset longitudinal axis section line O-O shown in FIG. 7B;

FIG. 8A is a front view of a second outer shell according to an embodiment;

FIG. 8B is a left side view of the second outer shell of FIG. 8A;

FIG. 8C is a perspective view of the second outer shell of FIG. 8A;

FIG. 8D is a perspective view of a peripheral seal assembled in the second outer shell of FIG. 8A;

FIG. 9A is an exploded view of a second semi-finished subassembly according to an embodiment;

FIG. 9B is a perspective view of the second semi-finished subassembly of FIG. 9A;

FIG. 10A is an exploded view of a third semi-finished subassembly according to an embodiment;

FIG. 10B is a perspective view of the third semi-finished subassembly of FIG. 10A;

FIG. 11A is a perspective view of a shell according to an embodiment, where the first outer shell of FIG. 7A and the second outer shell of FIG. 8A are assembled together via a peripheral seal to form the shell;

FIG. 11B is an exploded view of the shell of FIG. 11A;

FIG. 12 is a perspective view of a cover according to an embodiment;

FIG. 13A is an exploded view of an electrical connector according to an embodiment;

FIG. 13B is a perspective view of the electrical connector of FIG. 13A;

FIG. 14A is a perspective view of a mating electrical connector assembly according to an embodiment; and

FIG. 14B is an exploded view of the mating electrical connector assembly of FIG. 14A.

### DETAILED DESCRIPTION

The present disclosure will now be described in detail with reference to the accompanying drawings, which are provided as illustrative examples of the present disclosure to enable those skilled in the art to practice the present disclosure. It is noted that the following drawings and examples are not intended to limit the scope of the present disclosure to a single embodiment, but rather to make other embodiments possible by means of interchange of some or all of the elements described or illustrated. Furthermore, where known components may be used partially or wholly to implement certain elements of the present disclosure, only those parts of such known components necessary for understanding the present disclosure will be described, and detailed descriptions of other parts of such known components will be omitted so as not to obscure the present disclosure. Unless otherwise provided herein, embodiments described as being implemented in software, as will be understood by those skilled in the art, are not to be limited thereto, but may include embodiments implemented in hardware or a combination of software and hardware, and vice versa. In this specification, embodiments showing a singular component are not to be considered limiting; rather, the present disclosure is intended to encompass other embodiments including a plurality of identical components, unless otherwise explicitly stated herein, and vice versa. Furthermore, applicants do not intend for any term in this specification or the claims to be ascribed an uncommon or special meaning unless explicitly set forth as such. Additionally, the present disclosure encompasses present and future known equivalents of the known components referred to herein by way of illustration.

Unless otherwise specified, the terms “bottom” and “top,” “upper” and “lower,” etc., appearing in the content recorded in the present disclosure are all relative concepts. And the terms “corresponding” or “respective” appearing in the content recorded in the present disclosure refer to the correspondence between paired components that work cooperatively.

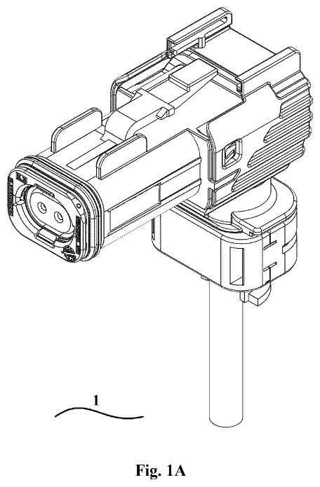

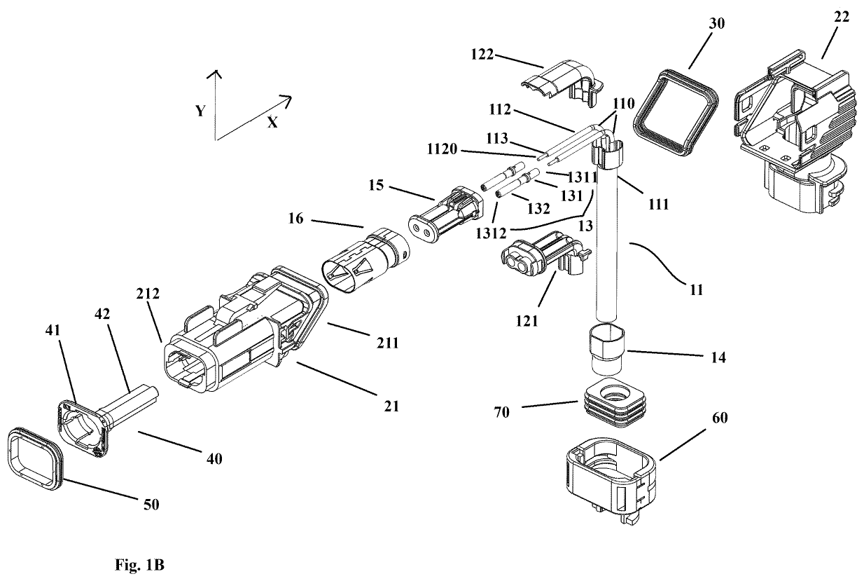

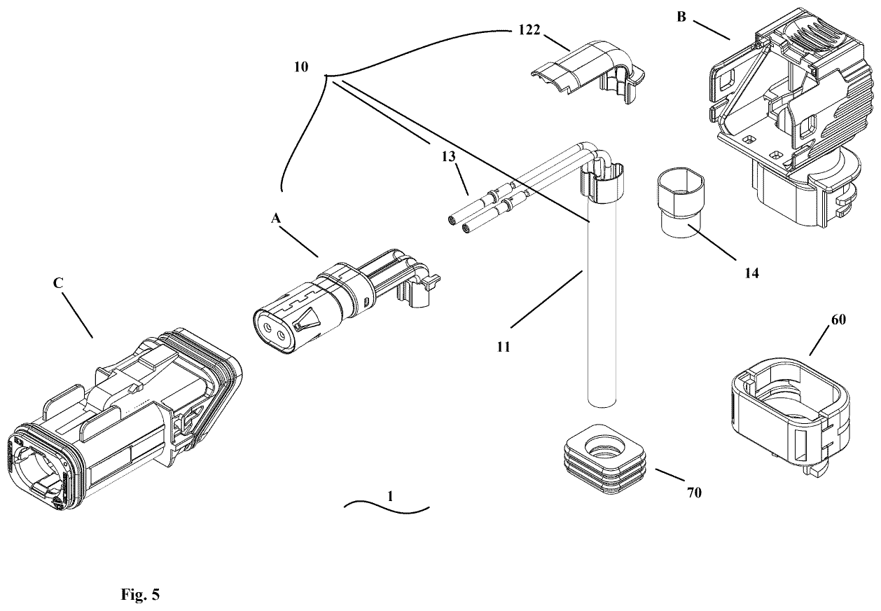

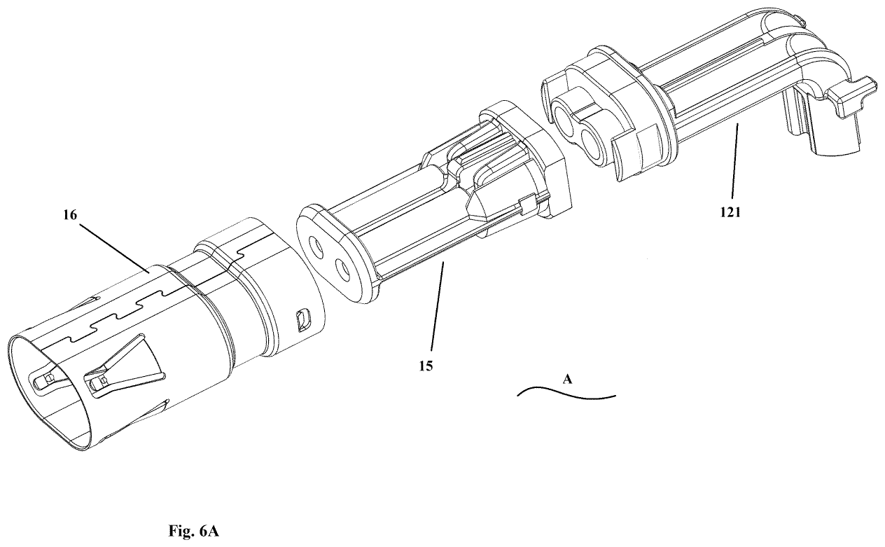

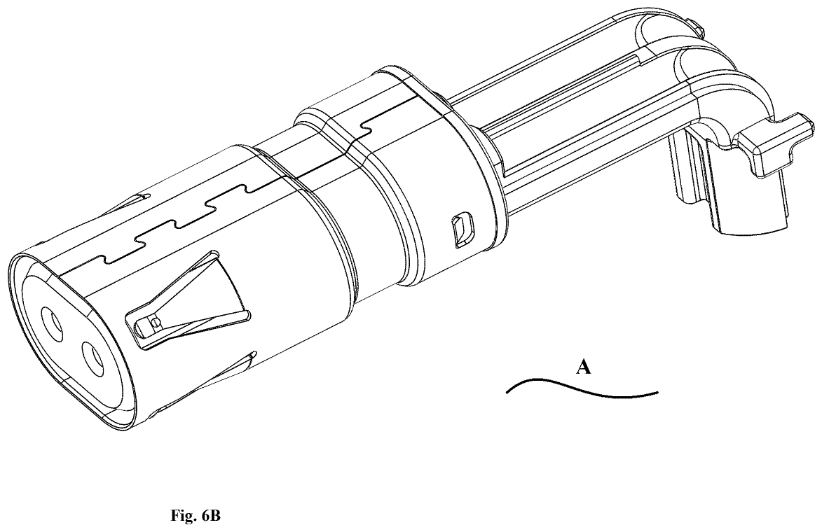

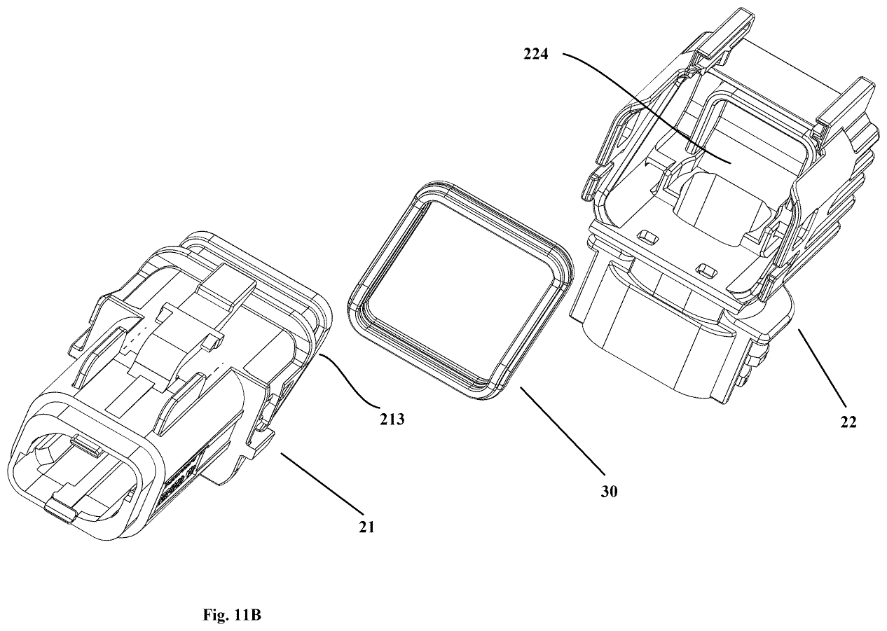

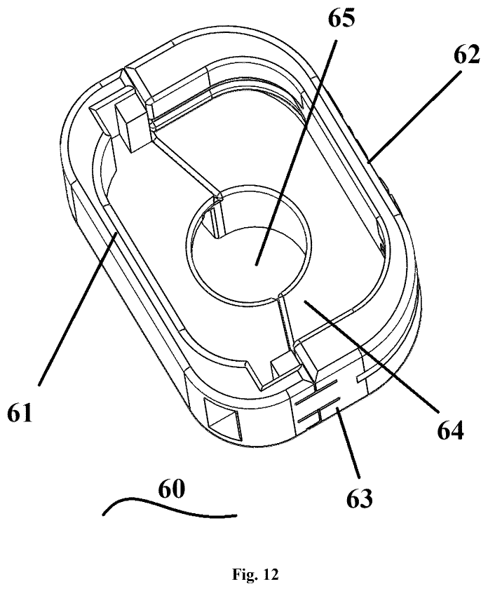

An exemplary embodiment of an electrical connector assembly 1, as shown in FIG. 1A, will now be described with reference to the figures. The electrical connector assembly 1 includes a terminal assembly 10, as shown in FIG. 5, and a shell 20, as shown in FIG. 11A.

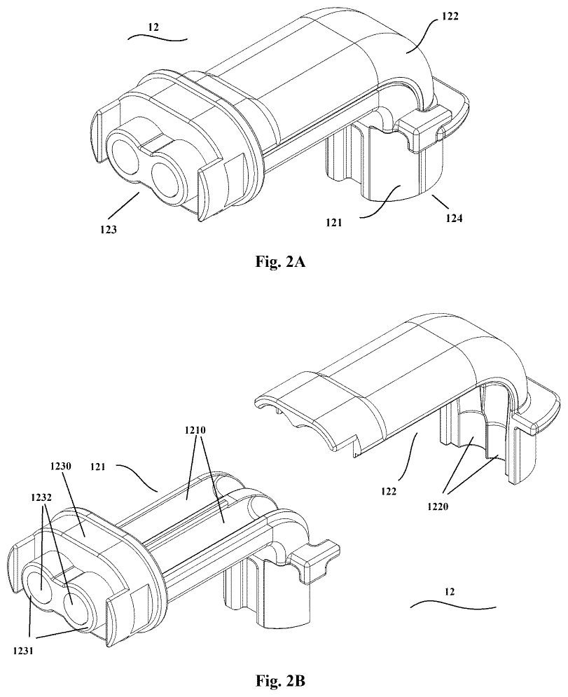

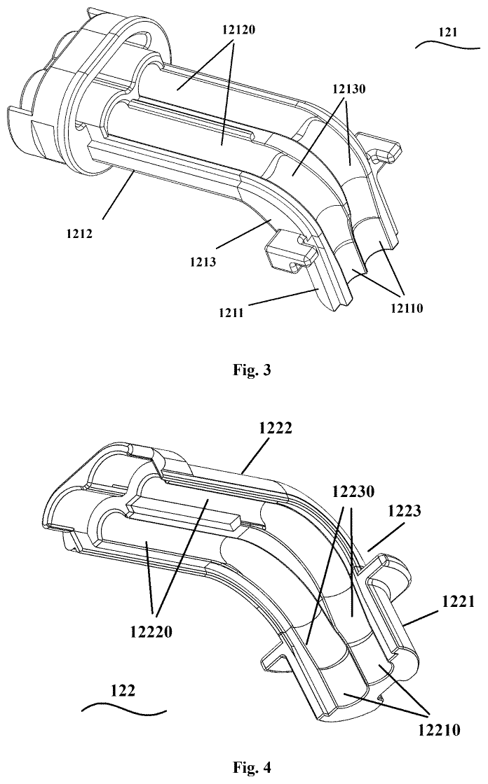

As shown in FIG. 2, the terminal assembly 10 includes a conductive wire 11, including a multi-strand wire harness 110, and a first housing portion 121 and a second housing portion 122, both of which are molded (e.g., an upper die-casting piece and a lower die-casting piece, e.g., molded from a metal material). For example, as shown in FIGS. 2A-2B, the first housing portion 121 and the second housing portion 122 are configured to fit with each other to define a hollow accommodation portion 12 for accommodating an inner core 112 of the multi-strand wire harness 110, from which a shielding layer 111 has been removed. The conductive core 1120 of the inner core 112, from which an insulating layer 113 has been removed, extends out of a leading-out end 123 of the accommodation portion 12.

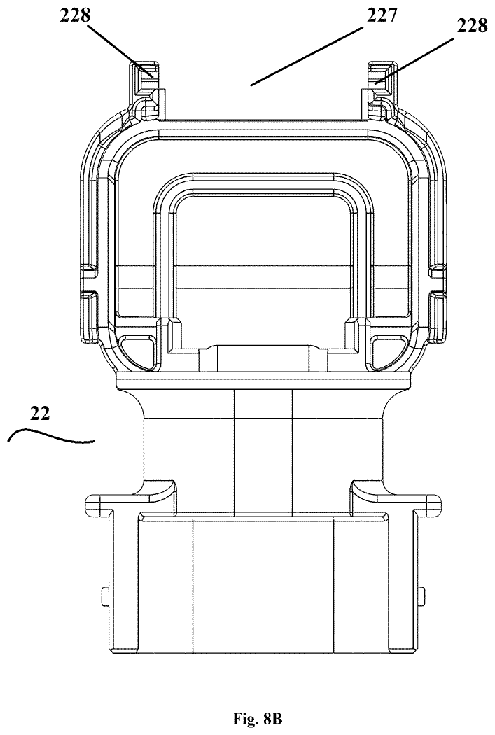

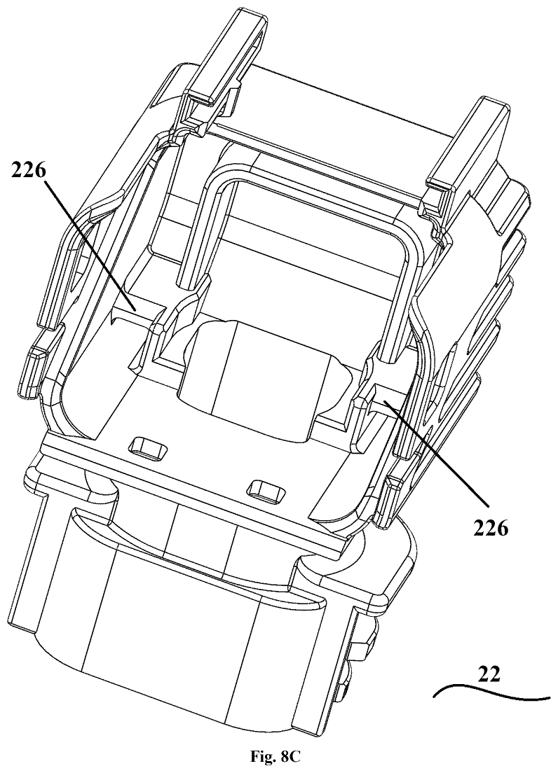

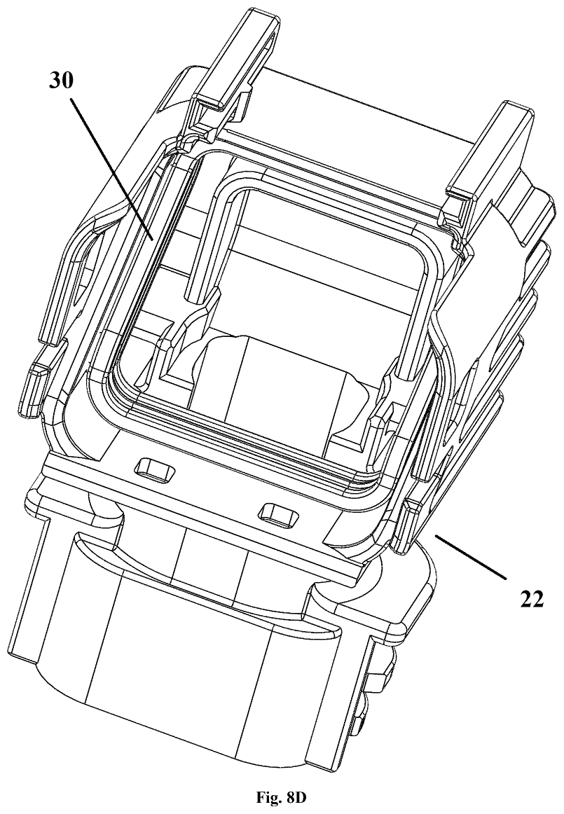

The shell 20 includes a first outer shell 21, as shown in FIGS. 1B, 7A-7E, 10A, and 11B, and a second outer shell 22, as shown in FIGS. 1B, 8A-9A, and 11B. The first outer shell 21 and the second outer shell 22 are configured to fit with each other to collectively define a hollow space for accommodating the terminal assembly 10. For example, as shown in FIG. 1B, the first outer shell 21 extends in a first direction X (e.g., a horizontal direction) and the second outer shell 22 extends in a second direction Y (e.g., a vertical direction) angled (e.g., at 90 degrees) relative to the first direction X. The multi-strand wire harness 110 and the accommodation portion 12 are constructed to be bent for being received within the shell 20.

As shown in FIGS. 1B and 5, the terminal assembly 10 further includes terminals 13. The terminals 13 are electrically connected to the conductive cores 1120 at the leading-out end 123. The terminals 13 are, for example, straight, and for example, extend in the first direction X; more specifically, for example, the terminals 13 are sleeved onto and in electrical contact with the conductive core 1120 in the first direction X. Correspondingly, for example, the conductive core 1120 extends out of the leading-out end 123 of the accommodation portion 12 in the first direction X.

As a specific example, as shown in FIG. 2A, the accommodation portion 12 defines a leading-in end 124, which portions of the multi-strand wire harness 110 without the shielding layer 111 extend into, a leading-out end 123 which respective conductive cores 1120 of the multi-strand wire harness 110 without the shielding layer 111 and without the insulating layer 113 extend out of, and a cavity between the leading-in end 124 and the leading-out end 123 for receiving the plurality of wire harnesses 110. The shielding layer 111 of the conductive wire 11 terminates at the leading-in end 124.

With this configuration, for example, based on a bent accommodation portion 12, which is formed by the first housing portion 121 and the second housing portion 122 being fitted to each other by insertion relative to each other and configured to receive the inner cores 112 of the multi-strand wire harness 110 of the conductive wire 11 from which the shielding layer 111 has been removed, and then utilizing a first outer shell 21 extending in a first direction X and a second outer shell 22 extending in a second direction Y respectively (the first direction X and the second direction Y being at angle to each other), thereby a 90-degree electrical connector assembly 1 having a novel structure is realized.

As shown in FIG. 2A, the accommodation portion 12 is assembled by fitting the second housing portion 122 detachably to the first housing portion 121 in the first direction X. The shielding layer 111 in the multi-strand wire harness 110 terminates at a leading-in end 124 of the accommodation portion 12 extending in the second direction Y. It should be noted that the expression, the second housing portion 122 is fitted detachably to the first housing portion 121 in the first direction X, only indicates the assembly direction of the second housing portion 122 and the first housing portion 121 relative to each other, for example the direction along which the insertion movement of the second housing portion 122 into the first housing portion 121 occurs, and does not exclude fitting of portions of the two in the second direction Y.

With this configuration, as an example, on one hand, via insertion and fitting of the first housing portion 121 and second housing portion 122 of the accommodation portion 12 in the first direction X, both of which are bent (e.g., an upper die-casting piece and a lower die-casting piece), the portion of the inner core 112 of the conductive wire 11 which extends within the accommodation portion 12 in the first direction X is defined; on the other hand, by the metal sheath 14 which is pressed, by crimping, circumferentially inwards against the leading-in end 124, the first housing portion 121 and the second housing portion 122 are prevented from being disengaged, and the portion of the inner core 112 of the conductive wire 11 which extends within the accommodation portion 12 in the second direction Y can also be defined. As such, embedded mutual fixation of these two die-casting pieces can be achieved in the first direction X, e.g., in the horizontal direction, by insertion fitting of these two parts of the accommodation portion 12, and in the second direction Y, e.g., in the vertical direction, these two die-casting pieces of the accommodation portion 12 are fixed relative to each other by crimping the metal sheath 14 in the form of a ferrule, achieving a 90-degree electrical connector assembly 1 which facilitates assembly and disassembly. More specifically, the metal sheath 14 is, for example, crimped into the form of a metal ring, such that the conductive wire 11 and the accommodation portion 12 which is die cast can be fixed together without being detached.

As shown in FIGS. 1B and 6A, the terminal assembly 10 further includes: a terminal housing 15. The terminal housing 15 is, for example, made of an insulating material. The terminal housing 15 is fitted to the leading-out end 123 in the first direction X and configured to fix the terminals 13 therein. The terminal assembly 10 also includes a shield 16, as shown in FIGS. 1B and 6A. The shield 16 is sleeved externally on the terminal housing 15 in the first direction X.

With this configuration, via the first housing portion 121 and the second housing portion 122, both of which are die cast and fitted to each other, respectively (e.g., an upper die-casting piece and a lower die-casting piece), as well as the metal sheath 14 and the shield 16 (e.g., a metal shield 16), the first housing portion 121, the second housing portion 122, the shield 16, and the metal sheath 14 collectively define an overall shielding structure for the inner cores 112, thereby achieving an overall shielding arrangement for the inner cores 112 of the conductive wire 11 from which the shielding layer 111 has been removed (i.e., the unshielded portion of the conductive wire 11), facilitating overall shielding to isolate external crosstalk.

As shown in FIG. 1B, each terminal 13 includes a terminal body 131 (e.g., a conductive terminal body 131 made of a metal material) extending in the first direction X. The terminal body 131 is provided with a hollow conductive contact end 1311 coaxially sleeved onto and in electrical contact with a respective conductive core 1120 at a proximal end of the terminal body 131 facing the leading-out end 123, and a plug-in end 1312 located at a distal end of the terminal body 131 facing away from the leading-out end 123 and being in the form of a hollow conical sleeve. Each terminal 13 further includes a terminal sleeve 132. The terminal sleeve 132 is partially sleeved onto a respective terminal body 131 such that the conductive contact end 1311 is exposed from the terminal sleeve 132, and the plug-in end 1312 is merely exposed at an end surface thereof from the terminal sleeve 132.

As an example, the plug-in end 1312 is provided with a plurality of slits extending longitudinally (e.g., aligned with the first direction X) away from the conductive contact end 1311 and spaced apart circumferentially from each other. Each terminal 13 is further provided with the hollow terminal sleeve 132 acting as a protective sleeve, which is at least partially sleeved on its outer surface longitudinally (more specifically, sleeved on the outer surface of the plug-in end 1312). Thereby a pin-type conductive terminal 13 firmly and reliably installed and electrically connected to the conductive wire 11 is formed for subsequent plugging with a mating electrical connector assembly 2.

With this configuration, an effective physical connection and an electrical contact from the conductive core 1120 of the unshielded inner core 112 of the conductive wire 11, which is further stripped of (i.e., removed therefrom) the insulating layer 113, to the terminals 13 is achieved, thereby implementing provision of a lead-out terminal 13 for the electrical connector assembly 1. The lead-out terminal 13 is thus firmly fixed within the terminal assembly 10 and effectively electrically connected to the conductive wire 11.

According to an exemplary embodiment of the present disclosure, as shown in FIG. 2B, for example, in the accommodation portion 12, the first housing portion 121 is provided with a plurality of first through slots 1210 extending therethrough, and the second housing portion 122 is provided with a plurality of second through slots 1220 extending therethrough. The plurality of first through slots 1210 and the plurality of second through slots 1220 fit with each other respectively in one-to-one correspondence so as to collectively define a plurality of channels allowing respective inner cores 112 of the multi-strand wire harness 110 to pass therethrough, with a cross-sectional dimension of each channel being greater than a cross-sectional dimension of a respective inner core 112 and less than a cross-sectional dimension of a portion of the multi-strand wire harness 110 having the shielding layer 111.

As shown in FIG. 2B, the leading-out end 123 is provided with an end wall 1230. The end wall 1230 is adjacent to and engaged with the terminal housing 15, and the end wall 1230 is formed, on a side thereof facing the terminal housing 15, with a plurality of hollow tube segments 1231 protruding in the first direction X (more specifically, for example, extending towards the shield 16 in the first direction X). Each hollow tube segment 1231 has a respective outlet through hole 1232 extending in the first direction X facing away from the terminal housing 15 and communicating with a respective channel.

As shown in FIG. 3, the first housing portion 121 includes: (1) a first lead-in portion 1211, extending in the second direction Y, and provided with a plurality of first lead-in grooves 12110 arranged in parallel; (2) a first lead-out portion 1212, extending in the first direction X, and provided with a plurality of first lead-out grooves 12120 arranged in parallel; and (3) a first transition portion 1213, constructed to be, for example, curved and coupled in a form of a rounded-corner transition between the first lead-in portion 1211 and the first lead-out portion 1212, and provided with a plurality of first transition grooves 12130. Each first transition groove 12130 communicates between a respective first lead-in groove 12110 and a respective first lead-out groove 12120 to define collectively a respective first through slot 1210, as shown in FIG. 2B.

As shown in FIG. 4, the second housing portion 122 includes: (1) a second lead-in portion 1221, extending in the second direction Y, and provided with a plurality of second lead-in grooves 12210 arranged in parallel; (2) a second lead-out portion 1222, extending in the first direction X, and provided with a plurality of second lead-out grooves 12220 arranged in parallel; and (3) a second transition portion 1223, constructed to be, for example, curved and coupled in a form of a rounded-corner transition between the second lead-in portion 1221 and the second lead-out portion 1222, and provided with a plurality of second transition grooves 12230. Each second transition groove 12230 communicates between a respective second lead-in groove 12210 and a respective second lead-out groove 12220 to define collectively a respective second through slot 1220, as shown in FIG. 4.

The plurality of first lead-in grooves 12110 and the plurality of second lead-in grooves 12210 define collectively, in a one-to-one correspondence respectively, a plurality of lead-in channels, as shown in FIG. 3, allowing respective inner cores 112 of the multi-strand wire harness 110 to pass therethrough. The plurality of first lead-out grooves 12120 and the plurality of second lead-out grooves 12220 define collectively, in a one-to-one correspondence respectively, a plurality of lead-out channels, as shown in FIG. 4, allowing respective inner cores 112 of the multi-strand wire harness 110 to pass therethrough. Additionally, the plurality of first transition grooves 12130 and the plurality of second transition grooves 12230 define collectively, in a one-to-one correspondence respectively, a plurality of transition channels allowing respective inner cores 112 of the multi-strand wire harness 110 to pass therethrough. Each transition channel communicates between a respective lead-in channel and a respective lead-out channel to define collectively a respective channel. As such, the lead-in channels, the transition channels, and the lead-out channels communicate continuously to define the channels of the accommodation portion 12 for accommodating the inner cores 112 of the conductive wire 11.

With this configuration, as an example, the first housing portion 121 and the second housing portion 122, both of which are die cast and bent, respectively can be realized, also facilitating the insertion fitting therebetween, thereby achieving an angularly bent structure (typically, for example, at 90-degrees) of the accommodation portion 12 which is die cast with hollow channels for assembly in a detachable manner and for receiving the unshielded portion of the multi-strand wire harness 110 of the conductive wire 11.

It should be particularly noted that the assembly of the various components of the electrical connector assembly 1 is performed in several stages, e.g., by at first forming several sub-assemblies separately, and then further assembling these sub-assemblies together. For example, FIG. 5 illustrates, in an exploded view, the overall structural arrangement of the electrical connector assembly 1 being further assembled from separately assembled multiple sub-assemblies. The specific structure of the electrical connector assembly 1 will be elaborated below specifically in conjunction with the discussion of the construction processes of the multiple sub-assemblies.

As an example, regarding the assembly of the terminal assembly 10, on one hand, a first semi-finished sub-assembly A, as shown in FIGS. 5-6B, is formed. As an example, for example as shown in FIGS. 6A-6B, at first, the first housing portion 121 which is die cast (e.g., a lower die-casting piece) is inserted, for example in the first direction X, towards the terminal housing 15; more specifically, for example, by inserting an end wall 1230 of the first housing portion 121 located at the leading-out end 123 of the accommodation portion 12 into and fitting with an end of the terminal housing 15 facing the first housing portion 121. Subsequently, the terminal housing 15, which has been fitted with the first housing portion 121 (e.g., the lower die-casting piece), is fully inserted into the shield 16 in the first direction X, thereby causing the shield 16 to be sleeved externally on the terminal housing 15 in the first direction X. As an example, mating features are respectively formed on the terminal housing 15 and on the shield 16, for example as illustrated, a protruding feature is formed on the outer surface of the terminal housing 15, and a through hole is correspondingly formed on the shield 16 for the protruding feature to be inserted and be limited by, thereby forming, for example, a detachable snap fit. As such, as shown in FIG. 6B, with this configuration and assembly process, the first semi-finished sub-assembly A is formed.

And, as a further example, regarding the assembly of the terminal assembly 10 implemented based on the first semi-finished sub-assembly A, on the other hand, electrical connection between the conductive wire 11 and the terminals 13 and the bent conductive wire 11 are formed, specifically, through the following steps:
At first, a wire stripping process is performed on the conductive wire 11, i.e., by a stripping process, the shielding layer 111 of the conductive wire 11 is removed over a first length starting from the front end of the conductive wire 11 backwards (the first length is, for example, greater than the length of the terminal sleeve 132 plus the total length of the channels within the bent accommodation portion 12); further, over a second length starting from the front end of the conductive wire 11 backwards (the second length is, for example, substantially equal to the length of the terminal body 131 minus the length of the terminal sleeve 132), the insulating layer 113 is further removed from the portion of the conductive wire 11 from which the shielding layer 111 has been removed.

Then, a terminal crimping process for crimping the terminals 13 onto the conductive wire 11 is performed, i.e., by at first inserting the conductive core 1120 of the conductive wire 11, from which the insulating layer 113 has been removed, into the hollow conductive contact end 1311 of the terminal body 131, forming electrical contact between the conductive core 1120 and the terminal body 131; subsequently, the terminal sleeve 132 is sleeved onto the outer surface of the terminal body 131. Thereby, crimping and electrical connection from the conductive wire 11 to the terminals 13 are achieved.

Then, a bending process is performed on the inner cores 112 of the conductive wire 11 from which the shielding layer 111 has been removed, thereby forming the bent conductive wire 11 which has been crimped to the terminals 13.

Afterwards, regarding the assembly of the terminal assembly 10, in another aspect, the terminals 13 and the bent conductive wire 11 that have been crimped together are inserted into the first semi-finished sub-assembly A in the first direction X, specifically inserted into the first through slots 1210 inside the first housing portion 121 (e.g., the lower die-casting piece).

Finally, regarding the assembly of the terminal assembly 10, the second housing portion 122 (e.g., the upper die-casting piece) is inserted and fitted with the first housing portion 121 (e.g., the lower die-casting piece) in the first direction X (e.g., the horizontal direction), whereby the second through slots 1220 of the housing portion fitted with the first through slots 1210 of the first housing portion 121 to collectively define a plurality of channels allowing respective inner cores 112 of the multi-strand wire harness 110 to pass therethrough; as an example, a cross-sectional dimension of each channel is greater than a cross-sectional dimension of the respective inner core 112 and less than a cross-sectional dimension of the portion of the multi-strand wire harness 110 having the shielding layer 111. Thereby, the portion of the conductive wire 11 having the shielding layer 111 (i.e., the portion from which the shielding layer 111 has not been stripped) is prevented from entering the plurality of channels of the accommodation portion 12.

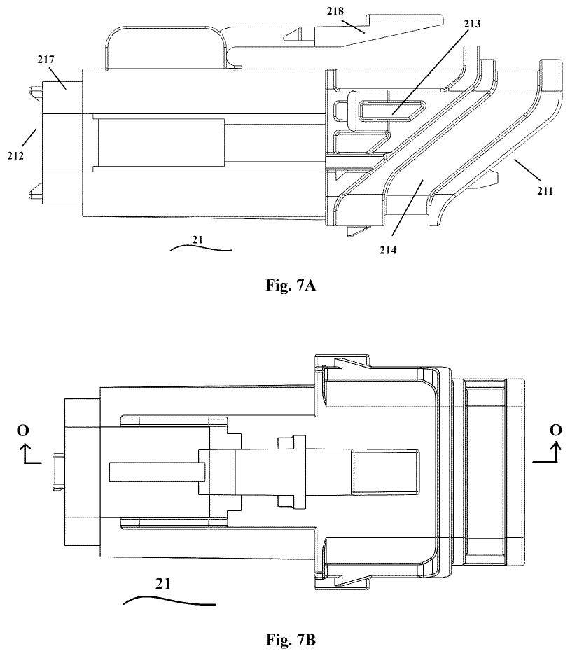

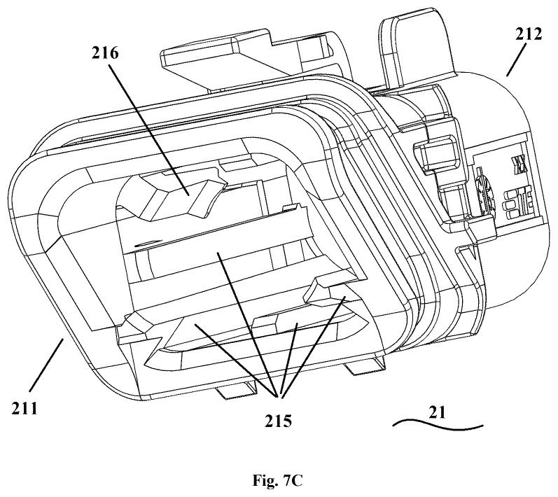

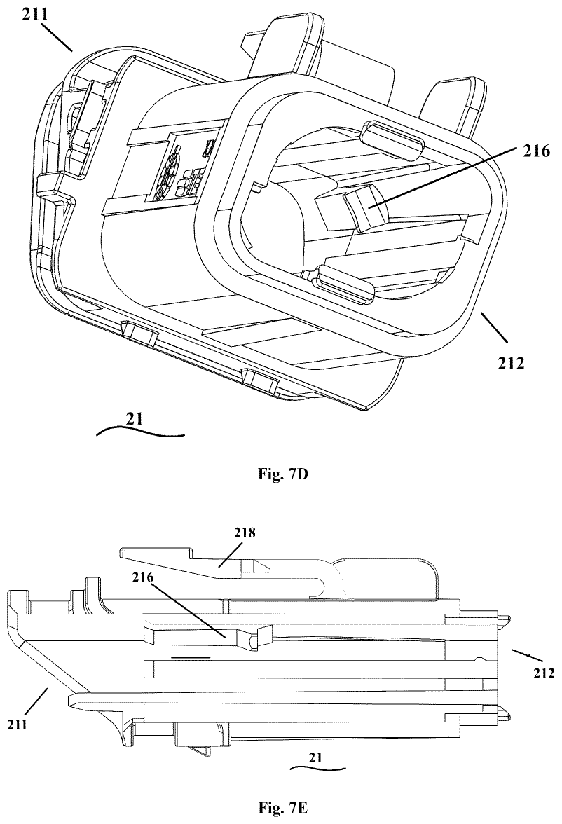

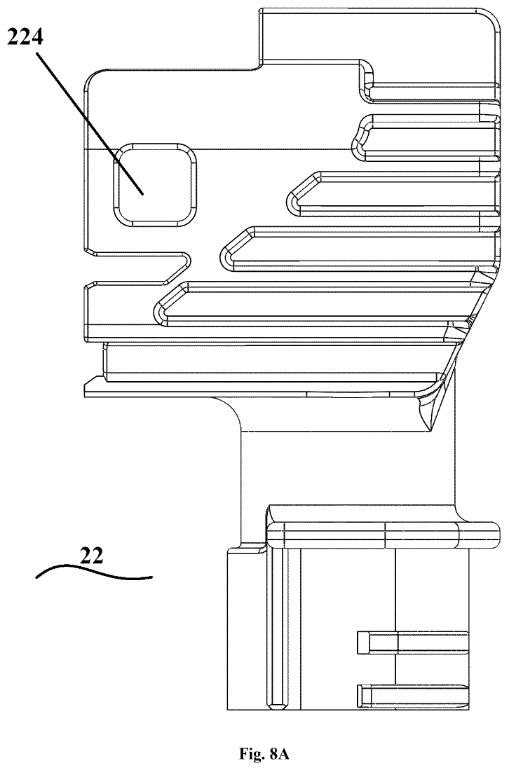

According to an exemplary embodiment of the present disclosure, for example, the first outer shell 21 is hollow, and is arranged to extend in the first direction X, and is provided with a first free end 211, as shown in FIGS. 7A and 7C-7E, facing the second outer shell 22 and a second free end 212, as shown in FIGS. 7A and 7C-7E, opposite to the first free end 211. The first outer shell 21 is configured to receive a first portion of the accommodation portion 12 extending in the first direction X, and the shield 16. The second outer shell 22 is hollow, and is arranged to extend in the second direction Y, and is configured to receive a second portion of the accommodation portion 12 extending in the second direction Y and the metal sheath 14.

As shown in FIG. 11A, the second outer shell 22 fits with the first outer shell 21 to form the shell 20. For example, the second outer shell 22 and the first outer shell 21 snap fit with each other at their respective outer side surfaces, and the second outer shell 22 partially covers the first outer shell 21 and the first portion of the accommodation portion 12.

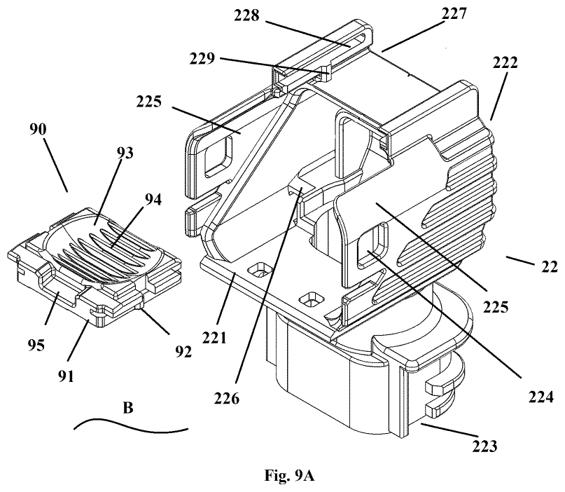

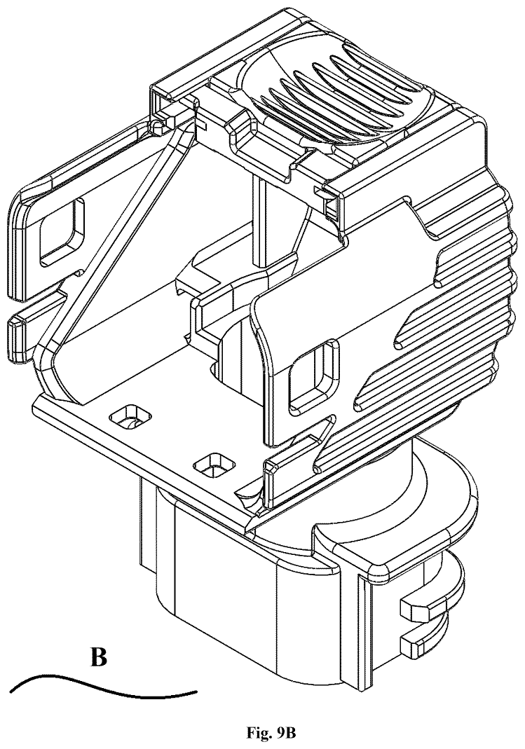

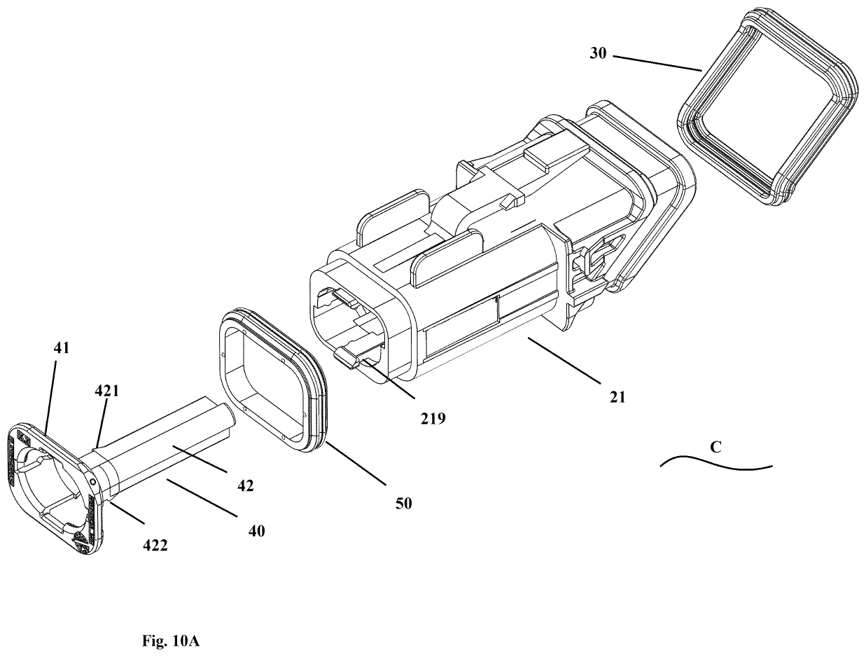

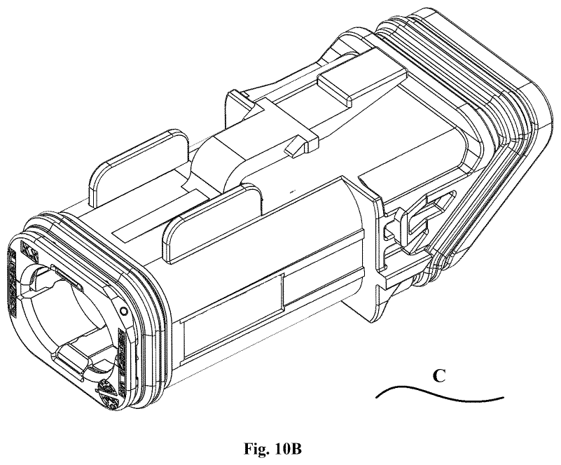

Additionally, as shown in FIGS. 7A and 9A, one of the first outer shell 21 and the second outer shell 22 is provided with protruding portions 213 on its opposing lateral outer surfaces, and the other of the first outer shell 21 and the second outer shell 22 is provided with recessed portions 224 on its opposing lateral outer surfaces. Each protruding portion 213 and a corresponding recessed portion 224 forming a snap fit to lock with each other.

As shown in FIGS. 1B, 10A, and 11B, the electrical connector assembly 1 further includes a peripheral seal 30. The peripheral seal 30 being constrained in a closed path on an outer surface of the first outer shell 21, and being compressed between the outer surface of the first outer shell 21 and an inner surface of the second outer shell 22 to form a seal therebetween. And, in response to the first outer shell 21 and the second outer shell 22 being snap-fitted in place with each other, the peripheral seal 30 is pressed between the first outer shell 21 and the second outer shell 22 to form a seal.

As shown in FIG. 7A, the first outer shell 21 is provided, at a proximal end of the first free end 211, with a surrounding groove 214 continuously recessed around the outer surface of the first outer shell 21. The surrounding groove 214 defines the closed path, and the peripheral seal 30 is constrained on the outer surface of the first outer shell 21 by being accommodated within the surrounding groove 214.

The first free end 211 is chamfered relative to the first direction X, such that edges of opposing lateral outer surfaces of the first outer shell 21 at the first free end 211 are at a first angle relative to the first direction X. The surrounding groove 214 and the peripheral seal 30 are also provided on the opposing lateral outer surfaces of the first outer shell 21 respectively at a second angle relative to the first direction X. For example, the second angle is equal to the first angle, for example they are both equal to an angle θ, preferably the angle θ is equal to 39°. If these angles are chosen to be closer to 0 degrees, the stroke required for the first outer shell 21 and the second outer shell 22 to move towards each other in the first direction X for assembly is larger. And it is required correspondingly that the peripheral seal 30 has a larger perimeter, and the seal is in turn correspondingly less reliable, and during the increased relative movement of the first outer shell 21 and the second outer shell 22, the seal is subjected to increased friction and is more prone to failure; in addition, if these angles are chosen to be closer to 90 degrees, the peripheral seal 30 approximates a sealing ring in a plane orthogonal to the first direction X, i.e., achieving a sealing effect closer to that of a conventional sealing ring.

Furthermore, as shown in FIG. 9A, the second outer shell 22 is provided with a mating end 221 which faces the first outer shell 21 and is chamfered relative to the first direction X. The second outer shell 22 is also provided with a pair of baffles 225, as shown in FIG. 9A, which are disposed opposite to each other, cover opposing outer sides of the mating end 221, and extend toward the first outer shell 21. The mating end 221 is configured to accommodate insertion of the first free end 211, and the mating end 221 is chamfered relative to the first direction X at the first angle such that an inclination direction of the mating end 221 is the same as a respective inclination direction of the first free end 211.

As a specific embodiment, for example, leading edges of respective edges of the two surfaces of the first outer shell 21 opposing each other in a vertical direction orthogonal to the lateral direction at the first free end 211 are stopped by inner surfaces at a closed rear end 222 of the second outer shell 22 opposite to the mating end 221 in the first direction X (the closed rear end 222 protruding, e.g., bulging, from a vertical wall of the second outer shell 22 in the first direction X away from the first outer shell 21). Thereby, a pre-stopping of the first outer shell 21 is achieved by the second outer shell 22.

As a more specific embodiment, for example, as shown in FIG. 9A, an inner wall of the second outer shell 22 (e.g., at a lower vertical surface of the inner wall near the closed rear end 222) is provided with at least one first stop member 226 extending towards the mating end 221. The at least one first stop member 226 being configured to block the first outer shell 21. The rear edge (trailing edge) of the respective edge of one of the two surfaces of the first outer shell 21 opposing each other in the vertical direction orthogonal to the lateral direction at the first free end 211 is stopped by the at least one first stop member 226. As an example, the first stop member 226 is in the form of a ramp or step raised from the first outer shell 21 towards the second outer shell 22 in the first direction X; for example, each first stop member 226 is in the form of a wedge-shaped block inclined downwards towards the mating end 221. Thereby, final stopping of the first outer shell 21 is achieved by the second outer shell 22.

And, by way of example, the portion of the periphery of the mating end 221 facing the first outer shell 21 on the lateral surfaces is chamfered relative to the first direction X at an angle substantially equal to the second angle. In response to the first free end 211 of the first outer shell 21 being inserted in place within the second outer shell 22 and being fully stopped by the second outer shell 22, the periphery of the first free end 211 is completely covered by the mating end 221, and is sealed by the peripheral seal 30 being pressed against the inner surface of the second outer shell 22.

Thus, with this configuration, during the process of the first outer shell 21 moving towards the second outer shell 22, e.g., in the first direction X, the peripheral seal 30, although it is inclined relative to the first direction X, is pressed against the inner surface of the second outer shell 22 substantially simultaneously to form a seal, and is then substantially simultaneously shielded by the pair of baffles 225 arranged laterally on the second outer shell 22, thereby facilitating the formation of a reliable circumferential seal pressed between the outer surface of the first outer shell 21 and the inner surface of the second outer shell 22 at a single moment during the process of the first outer shell 21 sliding into and fitting with the second outer shell 22.

As an example, firstly, for the second outer shell 22, before being assembled with the first outer shell 21, for example, a secondary lock 90, as shown in FIG. 9A, acting as a connector position assurance (CPA), is also inserted and fitted at a top side of the second outer shell 22, as shown in FIG. 9B, for subsequently utilizing the secondary lock 90 to achieve reliable locking between the electrical connector assembly 1 and a mating electrical connector assembly 2, thereby achieving effective structural locking of the electrical connector 100 as a whole. Specific details are discussed later.

The first outer shell 21 further includes: (1) as shown in FIG. 7C, a plurality of ribs 215, protruding inwards from an inner wall of the first outer shell 21 and extending in the first direction X, and arranged to be circumferentially spaced apart from each other, and configured to cooperatively limit an outer surface of the accommodation portion 12 by their respective inward top ends; and (2) as shown in FIGS. 7C-7E, an elastic cantilever 216, protruding inwards from the inner wall of the first outer shell 21 and extending in the first direction X towards the second free end 212 of the first outer shell 21 until a distal end of the elastic cantilever 216 terminates at the end wall 1230 of the leading-out end 123 of the accommodation portion 12. A flange of the second housing portion 122, as shown in FIGS. 2A-2B, of the accommodation portion 12 adjacent to the end wall 1230 of the leading-out end 123 (more specifically, for example, a rear side wall of the flange) presses the distal end of the elastic cantilever 216 towards the inner wall of the first outer shell 21.

The distal end of the elastic cantilever 216 is, for example, provided with a first inclined surface angled towards the second free end 212 of the first outer shell 21, and, for example, a second inclined surface angled towards the first free end 211 and inclined opposite to the first inclined surface, as well as a protruding rib further pointing towards the shield 16 between the first inclined surface and the second inclined surface.

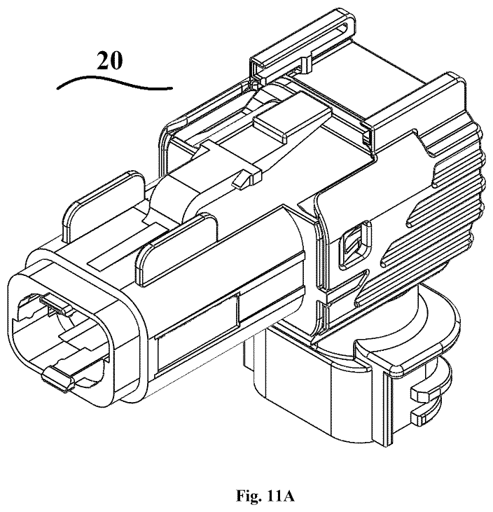

As shown in FIG. 7A, an annular recess 217 having a stepped longitudinal cross-section is formed at the second free end 212 of the first outer shell 21. As shown in FIG. 1B, the electrical connector assembly 1 further includes a retainer 40, for example acting as a terminal position assurance (TPA), and a gasket 50. The retainer 40, as shown in FIGS. 1B and 10A, includes an annular body 41 and a tab 42. The annular body 41 is sleeved onto the annular recess 217, and the tab 42 (e.g., in the form of a cantilever) extends from the annular body 41 towards the interior of the first outer shell 21. The gasket 50 is sleeved onto the annular recess 217 and pressed in the first direction X between the annular body 41 and the first outer shell 21, such that the tab 42 extends to be inserted between the inner wall of the first outer shell 21 and the distal end of the elastic cantilever 216 so as to retain the terminal assembly 10 in position relative to the first outer shell 21 by the elastic cantilever 216.

Based on this arrangement, typically, for example, at first the gasket 50 is sleeved onto the annular recess 217 having a stepped longitudinal cross-section at the second free end 212 of the first outer shell 21, then the retainer 40 which functions as the TPA is guided towards the second free end 212 of the first outer shell 21, such that at first, the tab 42, which extends longitudinally, of the retainer 40 (e.g., in the form of a cantilever extending from the annular body 41 of the retainer 40) extends into the interior of the first outer shell 21, and then the annular body 41, which is hollow, of the retainer 40 presses the gasket 50 in the first direction X so as to press the gasket 50 against an end step surface of the annular recess 217 in the first direction X. Finally, the peripheral seal 30 is sleeved into the surrounding groove 214 at the first free end 211 of the first outer shell 21.

As such, with this configuration and assembling process, the third semi-finished sub-assembly C is formed, thereby achieving sealing at the second free end 212 of the first outer shell 21, and the peripheral seal 30 is set at the first free end 211 of the first outer shell 21 for the first outer shell 21 to be connected, in a sealing manner, to the second outer shell 22.

And, in the assembling of the terminal assembly 10 with the third semi-finished sub-assembly C, first, in the already formed third semi-finished sub-assembly C, the tab 42 of the retainer 40 has already extended into the first outer shell 21, more specifically corresponding to FIG. 7E, for example, the tab 42 extends into a gap between the elastic cantilever 216 of the first outer shell 21 and the inner wall of the first outer shell 21. Then, the terminal assembly 10 is inserted into the first outer shell 21 in the first direction X, more specifically corresponding to FIG. 7E, the shield 16 in the terminal assembly 10 elastically presses the elastic cantilever 216 towards the inner wall of the first outer shell 21, until a rear end of the shield 16 located at the leading-out end 123 of the accommodation portion 12 completely passes the protruding rib, serving as the boundary between the first inclined surface and the second inclined surface of the elastic cantilever 216, and presses against the first inclined surface, and the flange of the second housing portion 122 (i.e., the upper die-casting piece) of the accommodation portion 12 adjacent to the end wall 1230 at the leading-out end 123 presses against the second inclined surface such that the distal end of the elastic cantilever 216 is thereby pressed towards the inner wall of the first outer shell 21.

Thus, with this configuration, the tab 42 of the retainer 40 is correspondingly pressed and clamped between the elastic cantilever 216, which is pushed by the terminal assembly 10, and the inner surface of the first outer shell 21, thereby also effectively ensuring firm fixation of the terminal assembly 10 and the terminals 13 contained therein relative to the inner surface of the first outer shell 21, i.e., also effectively ensuring reliable positioning and retention in position of the terminals 13 relative to the first outer shell 21.

FIG. 12 shows a schematic perspective view of a cover 60 according to an embodiment of the present disclosure.

As shown in FIG. 1B, the electrical connector assembly 1 further includes a cover 60 and a sealing gasket 70. The cover 60 is fitted with the shell 20 at the leading-in end 124 in the second direction Y. As shown in FIG. 12, the cover 60 includes a first segment 61 and a second segment 62 which are hinged together about a hinge portion 63 in a pivotable manner relative to each other. The first segment 61 and second segment 62 collectively defining a recess 64 facing the leading-in end 124, and a through hole 65 for the portion of the multi-strand wire harness 110 having the shielding layer 111 to extend therethrough. The sealing gasket 70 is accommodated in the recess 64 and pressed around the portion of the multi-strand wire harness 110 having the shielding layer 111.

As an example, the cover 60 is, for example, a single wire seal (SWS), and can serve as part of the shell 20, or alternatively as an accessory fitted with the shell 20. And, for example, fitting of the cover 60 with the shell 20 is achieved via cooperation between features on an inner surface of the cover 60 and mating features on an outer surface of a lower end of the shell 20 (e.g., of the second outer shell 22), such as a snap fit or hook fit, etc.

Thus, via the aforementioned peripheral seal 30, gasket 50, and the sealing gasket 70, a sealed electrical connector assembly 1 relative to the external environment is defined collectively.

For the terminal assembly 10 and the first semi-finished sub-assembly A contained therein, as an example, before performing the wire stripping process on the conductive wire 11, the sealing gasket 70 has been pre-sleeved onto the shielding layer 111 of the conductive wire 11. Then, the conductive wire 11 passes through the second outer shell 22, such that the sealing gasket 70 is located at a bottom 223 of the second outer shell 22 in the second direction Y. Subsequently, for example, the metal sheath 14 is sleeved onto the portion of the conductive wire 11 from which the shielding layer 111 will not be stripped, i.e., at the leading-in end 124, by crimping. Subsequently, the stripping process is performed.

And, for the electrical connector assembly 1, once the terminal assembly 10 containing the first semi-finished sub-assembly A is inserted into the third semi-finished sub-assembly C, and then assembled with the second semi-finished sub-assembly B, then further, for example in the second direction Y, the sealing gasket 70 is pushed to press against an outer surface of a bottom 223 of the second outer shell 22 to be fitted with the cover 60. Subsequently, the cover 60 is installed, and the first segment 61 and the second segment 62 of the cover 60 pivot relative to each other about the hinge portion 63 to close to accommodate the sealing gasket 70 within the recess 64 of the cover 60. The cover 60 is fitted with the bottom 223 of the second outer shell 22 in the second direction Y, thereby pushing the sealing gasket 70 in the second direction Y to seal to the bottom 223 of the second outer shell 22. Correspondingly, the terminal assembly 10 is also pushed towards the retainer 40, thereby causing the retainer 40 acting as the TPA to effectively ensure that the terminals 13 are in a pre-locked position relative to the shell 20.

Based on the above-described bent-type electrical connector assembly 1, the following advantageous technical effects compared to existing technical solutions in the art can be achieved:
The electrical connector assembly 1 of the solution of the present disclosure is based on upper and lower die-casting pieces that fit with each other, and is fixed in the horizontal direction by insertion fit of the two die-casting pieces relative to each other, and in the other angled direction, e.g., the vertical direction, is fixed by crimping to achieve the sleeved metal sheath 14. Thereby, the conductive wire 11 which is bent is accommodated, such that an electrical connector assembly 1 which is bent (e.g., at 90 degree) can be realized using straight terminals 13, abandoning conventional electrical connector assembly in the form in which conductive pieces are inserted separately in two directions angled relative to each other, or conventional electrical connector assembly in a form in which the terminals 13 themselves are bent. Thus, an alternative bent-type electrical connector assembly 1 is achieved through simple design and existing processes without significantly increasing the number of parts and at low cost.

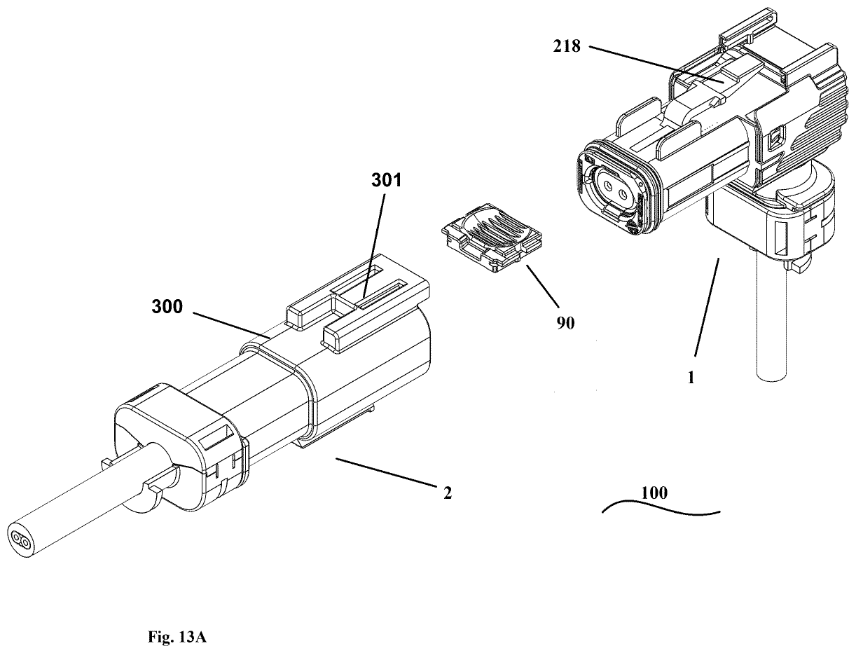

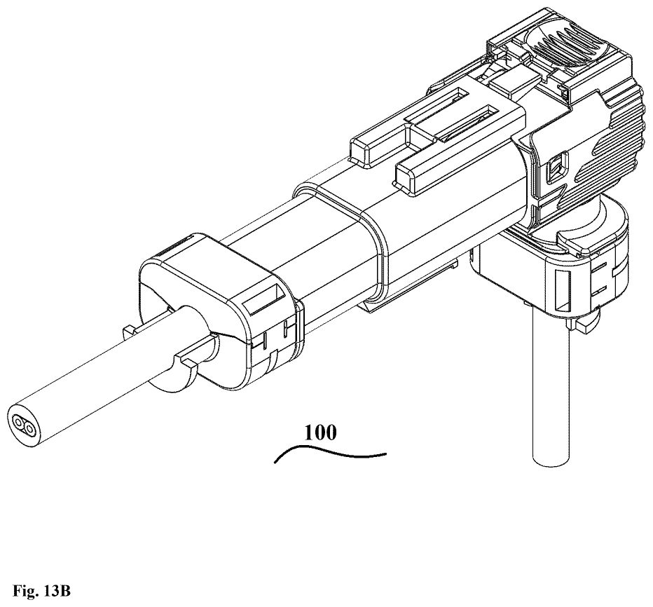

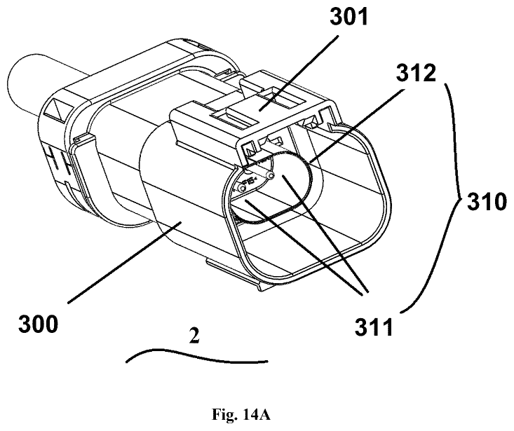

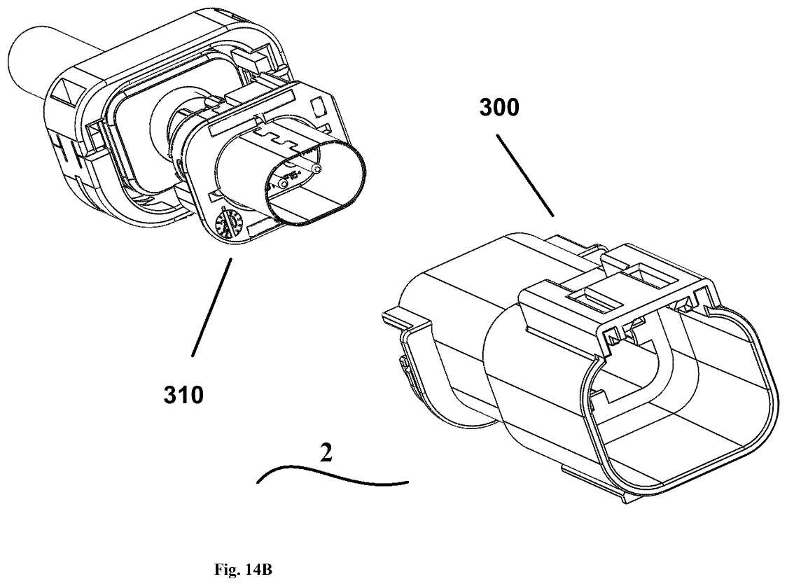

An exemplary embodiment of an electrical connector 100 will now be described with reference to FIGS. 1A-14B. The electrical connector 100 includes: the aforementioned electrical connector assembly 1, and a mating electrical connector assembly 2, as shown in FIGS. 14A-14B. The mating electrical connector assembly 2 includes a mating shell 300 and a receptacle defined by the mating shell 300 for insertion and docking of the electrical connector assembly 1. With this configuration, a complete bent-type (e.g., at 90 degrees) electrical connector 100 is achieved, which accommodates a bent conductive wire 11, thereby enabling a bent (e.g., at 90 degrees) electrical connector assembly 1 using straight terminals 13, abandoning conventional electrical connector assemblies 1 of the form where conductive pieces are inserted separately along two directions angled relative to each other, or conventional electrical connector assemblies 1 of the form where the terminals 13 themselves are bent.

In an exemplary embodiment according to the present disclosure, as an example shown FIG. 9A, a recessed portion 227 is formed at a top portion of the second outer shell 22, opposing guide rails 228 and opposing protrusions 229 below them are formed on opposing inner side walls of the recessed portion 227 in the first direction X. Each guide rail 228 being closed at an end thereof facing away from the first outer shell 21. As shown in FIG. 9A, the electrical connector 100 further includes a secondary lock 90. The secondary lock 90 includes a plate-like main body portion 91. The main body portion 91 being adapted to be accommodated in the recessed portion 227. The main body portion 91 achieves reciprocating translation by its opposing side edges being guided in the guide rails 228.

As shown in FIG. 9A, opposing elastic protrusions 92 are provided on opposing side surfaces of the main body portion 91. Each elastic protrusion 92 being configured to elastically deform in response to being pushed against the corresponding protrusion 229 to translate over the corresponding protrusion 229, and each protrusion 229 being configured to stop the corresponding elastic protrusion 92 that has elastically deformed and passed over it to prevent the corresponding elastic protrusion 92 from sliding back.

In a still further exemplary embodiment of the present disclosure, a locking member 218, as shown in FIGS. 7A and 7E, in the form of a cantilever extending towards the first free end 211 is provided on a top side of the first outer shell 21 of the electrical connector assembly 1, and a mating portion 301, as shown in FIG. 14A, is provided on a top side of the mating shell 300 of the mating electrical connector assembly 2 facing the locking member 218. The mating portion 301 being constructed to at least partially receive the locking member 218 and to press the locking member 218 towards an outer surface of the top side of the first outer shell 21. For example, the mating portion 301 is in the form of a recess that bulges outward and has an internal cavity for receiving the locking member 218.

The locking member 218 has a distal end tapering towards the main body portion 91, and the distal end is provided with a stepped portion descending towards the second free end 212. A front edge of the mating portion 301 facing the first outer shell 21 abuts against a surface of the stepped portion facing the mating shell 300.

As shown in FIG. 9A, the main body portion 91 is further provided with a descending wedge surface 95 formed on a side thereof facing the first outer shell 21 for pushing the distal end of the locking member 218 towards the mating shell 300. The main body portion 91 is configured to, in response to the mating portion 301 pushing the locking member 218 towards the main body portion 91, be manually pushed to use the wedge surface 95 to push the distal end of the locking member 218 such that the stepped portion abuts against the front edge of the mating portion 301.

As shown in FIG. 10A., a root portion of the tab 42 of the retainer 40 near the annular body 41 is provided with a first protrusion 421 and a second protrusion 422. Correspondingly, a mating protrusion 219, as shown in FIG. 10A, is provided on an inner wall of the first outer shell 21 near the second free end 212.

First, during the process of inserting the tab 42 into the first outer shell 21, the terminal assembly 10 is also pushed towards the retainer 40, such that when the retainer 40 acting as the TPA can effectively ensure that the terminals 13 are in a pre-locked position relative to the shell 20, the first protrusion 421 passes over the mating protrusion 219, while the second protrusion 422 has not yet passed over the mating protrusion 219, to prevent the retainer 40 acting as the TPA from detaching from the first outer shell 21.

Then, when the secondary lock 90 pushes the electrical connector assembly 1 towards the mating electrical connector assembly 2, the second protrusion 422 also passes over the mating protrusion 219, thereby causing the retainer 40 acting as the TPA to be further inserted towards the first outer shell 21, effectively ensuring that the terminals 13 are in a finally locked position relative to the shell 20. Thus, reliable positioning and retention in position of the terminals 13 relative to the mating electrical connector assembly 2 is reliably ensured.

As shown in FIG. 9A, a shallow indentation 93 is further formed on a top surface of the main body portion 91 of the secondary lock 90, and parallel multiple rows of ridges 94 are formed in the indentation 93, for a user's finger, e.g., thumb, to press the indentation 93 and push the multiple rows of ridges 94, to facilitate applying a pushing force to the secondary lock 90.

As shown in FIGS. 14A-14B, the electrical connector 100 further includes a mating terminal assembly 310. The mating terminal assembly 310 being accommodated and installed within the mating shell 300, and including a mating terminal housing 312 and the mating terminals 311 fixed within the mating terminal housing 312.

With this configuration, once the aforementioned bent-type electrical connector assembly 1 and the mating electrical connector assembly 2 are pushed towards each other for mating, the secondary lock 90 will be activated to further move the terminals 13 already in the pre-locked position further into the finally locked position.

And, considering that the electrical connector 100 provided in another aspect of the present disclosure includes the aforementioned bent-type electrical connector assembly 1, it thus also possesses the advantages of the aforementioned electrical connector assembly 1, which will not be repeated here.

The embodiments of the present disclosure provide a bent electrical connector assembly 1 and electrical connector 100 with a simple structure, and a method for forming the bent electrical connector assembly 1, aiming to achieve enhanced effective separate locking of the terminals 13 of the electrical connector 100 and the mating housing components respectively through a terminal position assurance member and a secondary lock 90 as a connector position assurance member, thereby achieving reliable assembly through simple assembly steps.

Thus, the bent electrical connector assembly 1 and its electrical connector 100 facilitate forming an accommodation portion 12 for the inner cores 112 of the multi-strand wire harness 110 from which the shielding layer 111 has been removed, through pre-processed mating bent housing portions 121,122, then achieving effective positioning and locking of the terminals 13 through a terminal position assurance member, and further achieving effective relative locking between different housing parts of the assembly housing through a secondary lock 90 as a connector position assurance member, thereby achieving separate locking of the terminals 13 of the electrical connector 100 and the mating housing components through the above two reliable relative fixations and limitation, improving structural strength of the assembly and reducing deformation and accumulated stress generated during the insertion process, and thereby facilitating improvement in assembly accuracy as well as impedance matching effect and high-frequency performance.

The above descriptions of the respective solutions of the bent-type electrical connector assembly 1 and the electrical connector 100 in the foregoing embodiments of the present disclosure are intended to be illustrative and not restrictive. Although the present disclosure has been described with reference to the accompanying drawings, the embodiments disclosed in the drawings are intended to exemplify preferred implementations of the present disclosure and should not be construed as a limitation of the present disclosure.

Therefore, those skilled in the art will understand that the embodiments described above are exemplary, and those skilled in the art may make improvements thereto, and structures described in various embodiments may be modified and freely combined without conflict in structure or principle, and such changes should fall within the protection scope of the present disclosure.

The breadth and scope of the present disclosure should not be limited by any of the above-described exemplary embodiments, but should be defined only in accordance with the following claims and their equivalents.

It should be noted that the word “comprising” does not exclude other elements or steps, and the word “a” or “an” does not exclude a plurality. Furthermore, any element reference signs in the claims should not be construed as limiting the scope of the present disclosure.

1. An electrical connector assembly, comprising:
a terminal assembly including a conductive wire having a multi-strand wire harness, and a first housing portion and a second housing portion which are both molded and fit with each other to define a hollow accommodation portion for accommodating inner cores of the multi-strand wire harness from which a shielding layer has been removed, conductive cores of the inner cores, from which insulating layers have been removed, extend out of a leading-out end of the accommodation portion; and
a shell including a first outer shell and a second outer shell which fit with each other to collectively define a space for accommodating the terminal assembly, the first outer shell extends in a first direction and the second outer shell extends in a second direction angled relative to the first direction, the multi-strand wire harness and the accommodation portion are bent and received within the shell, terminals of the terminal assembly are electrically connected to the conductive cores at the leading-out end.

2. The electrical connector assembly of claim 1, wherein the accommodation portion is assembled by fitting the second housing portion detachably with the first housing portion in the first direction, the shielding layer of the multi-strand wire harness terminates at a leading-in end of the accommodation portion extending in the second direction, and the electrical connector assembly further comprises a metal sheath pressed circumferentially inwards against the leading-in end by crimping.

3. The electrical connector assembly of claim 1, wherein the terminal assembly further comprises a terminal housing and a shield, the terminal housing is fitted with the leading-out end in the first direction and fixes the terminals therein, the shield is sleeved externally on the terminal housing in the first direction.

4. The electrical connector assembly of claim 3, wherein each terminal includes a terminal body and a terminal sleeve, the terminal body extends in the first direction and has a hollow conductive contact end and a plug-in end, the hollow conductive contact end is coaxially sleeved onto and in electrical contact with a respective conductive core at a proximal end of the terminal body facing the leading-out end, the plug-in end is located at a distal end of the terminal body facing away from the leading-out end and is in a form of a hollow conical sleeve, the terminal sleeve is partially sleeved onto the respective terminal body such that the conductive contact end is exposed from the terminal sleeve, and the plug-in end is merely exposed at an end surface thereof from the terminal sleeve.

5. The electrical connector assembly of claim 3, wherein the first housing portion has a plurality of first through slots extending therethrough, and the second housing portion has a plurality of second through slots extending therethrough, each first through slot is fitted with one second through slot so as to collectively define a plurality of channels, each channel allowing a respective inner core of the multi-strand wire harness to pass therethrough, a cross-sectional dimension of each channel is greater than a cross-sectional dimension of a respective inner core and less than a cross-sectional dimension of a portion of the multi-strand wire harness having the shielding layer.

6. The electrical connector assembly of claim 5, wherein the leading-out end has an end wall adjacent to and engaged with the terminal housing, the end wall is formed on a side thereof facing the terminal housing, with a plurality of hollow tube segments protruding in the first direction, each hollow tube segment has a respective outlet through hole extending in the first direction facing away from the terminal housing and communicating with a respective channel.

7. The electrical connector assembly of claim 5, wherein the first housing portion includes a first lead-in portion, a first lead-out portion, and a first transition portion, the first lead-in portion extends in the second direction and has a plurality of first lead-in grooves arranged in parallel, the first lead-out portion extends in the first direction and has a plurality of first lead-out grooves arranged in parallel, the first transition portion is curved and coupled in a form of a rounded-corner transition between the first lead-in portion and the first lead-out portion, the first transition portion has a plurality of first transition grooves, each first transition grooves communicates between a respective first lead-in groove and a respective first lead-out groove to collectively define a respective first through slot.

8. The electrical connector assembly of claim 7, wherein the second housing portion includes a second lead-in portion, a second lead-out portion, and a curved second transition portion, the second lead-in portion extends in the second direction and has a plurality of second lead-in grooves arranged in parallel, the second lead-out portion extends in the first direction and has a plurality of second lead-out grooves arranged in parallel, the curved second transition portion is curved and coupled in a form of a rounded-corner transition between the second lead-in portion and the second lead-out portion, the curved second transition portion has a plurality of second transition grooves, each second transition groove communicates between a respective second lead-in groove and a respective second lead-out groove to collectively define a respective second through slot.

9. The electrical connector assembly of claim 8, wherein the plurality of first lead-in grooves and the plurality of second lead-in grooves collectively respectively define a plurality of lead-in channels, each lead-in channel allowing respective inner cores of the multi-strand wire harness to pass therethrough, the plurality of first lead-out grooves and the plurality of second lead-out grooves collectively respectively define a plurality of lead-out channels, each lead-out channel allowing respective inner cores of the multi-strand wire harness to pass therethrough, and the plurality of first transition grooves and the plurality of second transition grooves collectively respectively define a plurality of transition channels, each transition channel allowing respective inner cores of the multi-strand wire harness to pass therethrough, each of the transition channels communicating between a respective lead-in channel and a respective lead-out channel to define collectively a respective channel.

10. The electrical connector assembly of claim 6, wherein the first outer shell is hollow, is arranged to extend in the first direction, has a first free end facing the second outer shell, and has a second free end opposite to the first free end, the first outer shell receives the shield and a first portion of the accommodation portion extending in the first direction, the second outer shell is hollow, is arranged to extend in the second direction, and receives a metal sheath and a second portion of the accommodation portion extending in the second direction, the second outer shell is fitted with the first outer shell to form the shell.

11. The electrical connector assembly of claim 10, wherein the second outer shell and the first outer shell snap fit with each other at their respective outer side surfaces, the second outer shell partially covers the first outer shell and the first portion of the accommodation portion.

12. The electrical connector assembly of claim 10, further comprising a peripheral seal constrained in a closed path on an outer surface of the first outer shell and compressed between the outer surface of the first outer shell and an inner surface of the second outer shell to form a seal therebetween.

13. The electrical connector assembly of claim 12, wherein the first outer shell has, at a proximal end of the first free end, a surrounding groove continuously recessed around the outer surface of the first outer shell, the surrounding groove defines the closed path, the peripheral seal is constrained on the outer surface of the first outer shell by being accommodated within the surrounding groove.

14. The electrical connector assembly of claim 13, wherein the first free end is chamfered relative to the first direction such that edges of opposing lateral outer surfaces of the first outer shell at the first free end are at a first angle relative to the first direction, the surrounding groove and the peripheral seal are also provided on the opposing lateral outer surfaces of the first outer shell respectively at a second angle relative to the first direction, the second angle is equal to the first angle.

15. The electrical connector assembly of claim 14, wherein the second outer shell has a mating end and a pair of baffles, the mating end faces the first outer shell and is chamfered relative to the first direction, the pair of baffles are disposed opposite to each other, cover opposing outer sides of the mating end, and extend toward the first outer shell, the mating end accommodates insertion of the first free end, the mating end is chamfered relative to the first direction at the first angle such that an inclination direction of the mating end is the same as a respective inclination direction of the first free end.

16. The electrical connector assembly of claim 1, wherein the first outer shell includes a plurality of ribs and an elastic cantilever, the plurality of ribs protrude inwards from an inner wall of the first outer shell, extend in the first direction, are circumferentially spaced apart from each other, and cooperatively limit an outer surface of the accommodation portion by their respective inward top ends, the elastic cantilever protrudes inwards from the inner wall of the first outer shell and extends in the first direction towards a second free end of the first outer shell until a distal end of the elastic cantilever terminates at an end wall of the leading-out end of the accommodation portion, a flange of the second housing portion of the accommodation portion adjacent to the end wall of the leading-out end presses against the distal end of the elastic cantilever towards the inner wall of the first outer shell.

17. The electrical connector assembly of claim 16, wherein an annular recess having a stepped longitudinal cross-section is formed at the second free end of the first outer shell, and the electrical connector assembly further comprises a retainer and a gasket, the retainer includes an annular body and a tab extending from the annular body towards an interior of the first outer shell, the annular body is sleeved onto the annular recess, the gasket is sleeved onto the annular recess and pressed in the first direction between the annular body and the first outer shell, such that the tab extends to be inserted between the inner wall of the first outer shell and the distal end of the elastic cantilever so as to retain the terminal assembly in position relative to the first outer shell by the elastic cantilever.

18. The electrical connector assembly of claim 2, further comprising a cover and a sealing gasket, the cover is fitted with the shell at the leading-in end in the second direction, the cover includes a first segment and a second segment which are hinged together about a hinge portion in a pivotable manner relative to each other, the first segment and second segment collectively define a recess facing the leading-in end and a through hole, a portion of the multi-strand wire harness having the shielding layer extends through the through hole, the sealing gasket is accommodated in the recess and pressed around the portion of the multi-strand wire harness having the shielding layer.

19. An electrical connector, comprising:
an electrical connector assembly including a terminal assembly and a shell, the terminal assembly includes a conductive wire having a multi-strand wire harness, and a first housing portion and a second housing portion which are both molded and fit with each other to define a hollow accommodation portion for accommodating inner cores of the multi-strand wire harness from which a shielding layer has been removed, conductive cores of the inner cores, from which insulating layers have been removed, extend out of a leading-out end of the accommodation portion, the shell includes a first outer shell and a second outer shell which fit with each other to collectively define a space for accommodating the terminal assembly, the first outer shell extends in a first direction and the second outer shell extends in a second direction angled relative to the first direction, the multi-strand wire harness and the accommodation portion are bent and received within the shell, terminals of the terminal assembly are electrically connected to the conductive cores at the leading-out end; and
a mating electrical connector assembly, the mating electrical connector assembly includes a mating shell and a receptacle defined by the mating shell for insertion and docking of the electrical connector assembly.
